(19) United States
(12) Patent Application Publication
(10) Pub. No.: US 2021/0125132 A1
(43) Pub. Date: Apr. 29, 2021

(54) USER CAPABILITY SCORE

(71) Applicant: HEWLETT-PACKARD DEVELOPMENT COMPANY, L.P., Spring, TX (US)

(72) Inventors: Ricardo Moreira, Porto Alegre (BR); Lucia Maciel, Porto Alegre (BR); Alessandro Carlos Hunhoff, Porto Alegre (BR); Ricardo Alexandre de Oiveria Staudt, Porto Alegre (BR); Ricardo Miotto Redin, Porto Alegre (BR); Thaua Garcia Silveria, Porto Alegre (BR); Alan Aguirre, Porto Alegre (BR); Leandro Cado, Porto Alegre (BR)

(21) Appl. No.: 16/604,073

(22) PCT Filed: Oct. 9, 2017
(86) PCT No.: PCT/US2017/055720

§ 371 Date: Oct. 9, 2019

(51) Int. Cl. G06Q 10/06

(52) U.S. Cl. CPC G06Q 10/06398

(57) ABSTRACT

Examples disclosed herein relate to assigning a capability score to a user based on a set of actions associated with a task performed by the user, receiving a support request from the user, and directing the user to one of a plurality of support options based on the assigned capability score.

### BACKGROUND

Users often complete a myriad of tasks relating to productivity devices including computers, mobile devices, and printers. When these users encounter problems with these devices, they often need to seek out support information or intervention.

### BRIEF DESCRIPTION OF THE DRAWINGS

In the accompanying drawings, like numerals refer to like components or blocks. The following detailed description references the drawings, wherein:

FIG. 1 is a block diagram of an example computing device for providing a user capability score;

FIG. 2 is a flowchart of an example of a method for providing a user capability score; and

FIG. 3 is an example system for providing a user capability score.

### DETAILED DESCRIPTION

Support services may comprise a range of customer assistance initiatives provided by enterprises in order to address issues with products or services for cost effective and productive product usage. In some situations, the more complex and specific the product or service, the more specialized the support that may need to be provided.

In some situations, customer usage of products and services with respect to various task flows may be captured and analyzed. For example, a user may complete a series of steps or actions to accomplish a task, such as clearing a paper jam in a printer. The analysis of the specific actions taken by that user may be used to define a score for the user's capability compared to an ideal and/or expected task flow. The capability score may then be used to customize which support options and/or marketing campaigns may be presented to the user.

Support options are often subdivided into levels depending on customer and business needs to address issues in a cost effective and time satisfactory manner. Different support levels and options, from in-person support and training to online knowledge bases or Frequently Asked Question (FAQ) lists may each benefit from specific training and experience for its users. The more experienced a user is about a given situation, the less detail is often required to be provided to address the user's issue. Therefore, being able to measure the customer's knowledge on a product's operation may lead to more precise and understandable technical support. With the user capability score, the technical support options may be customized to better attend the user by providing an appropriate level of detail and explanation. It will also allow for dynamic self-service options to be tailored to the user needs. The capability score may also allow a company to route support calls to an appropriate service agent tier.

The capability score allows quantifying and understanding user capabilities when using a complex computer application or device. The user actions may be tracked and recorded by generating footprints—the sequence of user steps on an application or device control interface. The footprints may contain time annotations to register the moment each action was executed by the customer.

The set of action footprints from numerous users may be analyzed and the most efficient footprint may be recorded as an expected set of actions for an experienced user. The most efficient footprint may, for example, comprise the footprint with the fewest number of actions, the least amount of time to complete, and/or a balance of both number of steps and time factors. This expected footprint may be configured and/or identified by an experienced user and/or a developer of the product, application, device, etc.

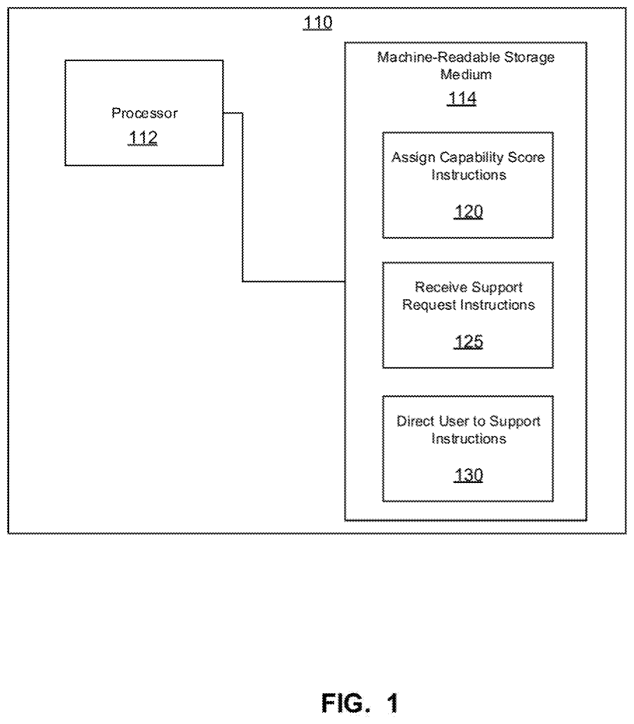

FIG. 1 is a block diagram of an example computing device 110 for providing a user capability score. Computing device 110 may comprise a processor 112 and a non-transitory, machine-readable storage medium 114. Storage medium 114 may comprise a plurality of processor-executable instructions, such as assign capability score instructions 120, receive support request instructions 125, and direct user to support instructions 130. In some implementations, instructions 120, 125, 130 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 125, 130.

Executable instructions 120, 125, 130 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Assign capability score instructions 120 may assign a capability score to a user based on a set of actions associated with a task performed by the user. In some implementations, the task may comprise a complexity score. Such a complexity score may, for example, be based upon a number of steps in an expected set of actions associated with the task and/or an expected time to complete an expected set of actions. Other factors may also be used to establish the complexity score, such as the need for interactions with different services, programs, hardware, and/or other users.

The capability score may be assigned on a user by user basis and may be associated with a profile and/or account for that user. For example, a user may have a corporate account to access a network and associated resources such as software, online tools, printers, copiers, etc. The user's actions associated with completing specific tasks may be recorded and/or measured in order to help determine the capability score. Capability scores are referred to herein as a hierarchy for convenience (e.g., a more experienced user may be described as having a higher capability score). Capability scores may be tracked according to such a hierarchy, via a numeric (e.g., one to five) and/or text-based manner (e.g., “novice”, “intermediate”, “expert”).

In some implementations, assign capability score instructions 120 may receive the set of actions associated with the task from the user and compare the received set of actions to the expected set of actions associated with the task. In some implementations, assign capability score instructions 120 may measure a time for the user to complete each of the set of actions associated with the task. Assign capability score instructions 120 may comprise instructions for receiving the set of actions associated with the task from the user and comparing a time taken by the user to complete the received set of actions to the time to complete the expected set of actions associated with the task.

For example, in a recorded workflow, a user may set up a new printing device by installing software and/or drivers, connecting to the device, configuring various options such as network sharing, and printing a test page. This may be compared to an expected set of steps as recorded by an expert user and/or product developer. This comparison may take into account the time to complete each step, the use of additional steps, such as looking up a help document, resetting configurations and/or going back a step, and/or a complexity associated with the task. Setting up a new printer, for example, may comprise a low complexity task due to a relatively few number of steps and short period of time to complete. A user who took 8 steps to complete such a low complexity task, when an expected set comprises only 5 steps, may for example be assigned a lower capability score than a user who completed the same task in 6 steps. Similarly, a user who took three times as long as the expected set of steps took to complete to complete the steps associated with an action may be assigned a lower capability score than a user who took twice as long as the same expected set of steps. Different mixes of time, number of steps, and complexity factors may be used to establish the capability score for a user depending on the situations and actions being undertaken; the preceding are merely illustrative examples.

Assign capability score instructions 120 may comprise instructions to assign a second capability score to a second user based on a second set of actions associated with the task performed by the user. That is, different users may be assigned different capability scores based on the steps used, time taken, or other factors associated with completing the same task. In some implementations, users' capability scores may be periodically re-evaluated and raised or lowered.

Receive support request instructions 125 may receive a support request from the user. For example, a user may submit a helpdesk ticket, visit a documentation website, open a help menu, and/or take other actions indicative of seeking assistance in accomplishing a task.

Direct user to support instructions 130 may direct the user to one of a plurality of support options based on the assigned capability score. In some implementations, the plurality of support options may comprise connecting the user to a live support agent, connecting the user to an interactive guide, and directing the user to a support document. The lower the user's capability score, the more assistance may be provided. For example, a beginner may be directed to a live-chat session with support personnel in order to walk the user through each step associated with their support request. An intermediate capability user may be connected with an automated system that provides pre-selected guidance to completing the same steps in the understanding that such a capable user may not need to ask additional questions of a live support agent. Continuing the example, an expert capability user may be provided with support documentation that includes advanced options and additional details for a given action the user may be trying to complete. In some implementations, a user who requires additional support beyond what is provided may have their capability score lowered.

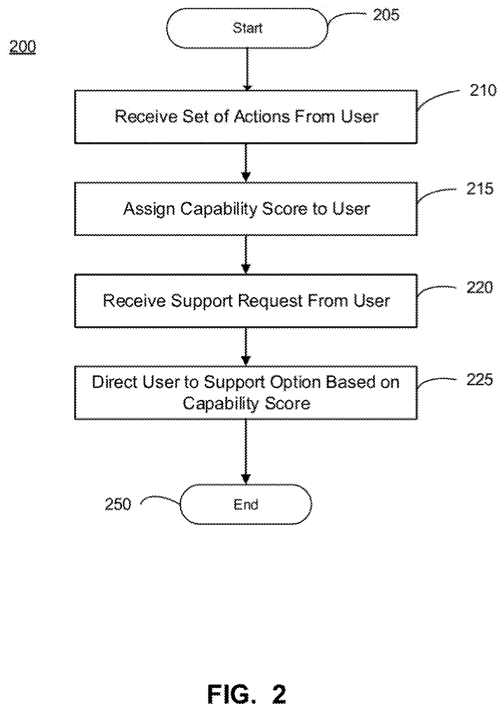

FIG. 2 is a flowchart of an example method 200 for providing a user capability score. Although execution of method 200 is described below with reference to computing device 110, other suitable components for execution of method 200 may be used.

Method 200 may begin at stage 205 and advance to stage 210 where device 110 may receive a set of actions associated with a task from a user. For example, a user may have a corporate account to access a network and associated resources such as software, online tools, printers, copiers, etc. The user's actions associated with completing specific tasks may be recorded and/or measured in order to help determine the capability score. The recording of actions may, for example, be done via software agents included in other programs, such as installation programs, and/or may comprise separate software executing on the user's computer. For example, an IT support application may run on corporate laptops that records user behavior on the laptop. These recorded actions may comprise time information, such as how long the user took to complete each action, whether any help files or other documentation were accessed, whether the user consulted other users (e.g., via an instant message and/or email program), etc.

Method 200 may then advance to stage 215 where device 110 may assign a capability score to the user by comparing the received set of actions to an expected set of actions associated with the task. Assigning the capability score to the user by comparing the received set of actions to the expected set of actions associated with the task may comprise, for example identifying deviations between the received set of actions and the expected set of actions and/or identifying a complexity score associated with the task. In some implementations, a complexity score may be based on, for example, a number of steps in the expected set of actions and a time to complete the expected set of actions.

For example, assign capability score instructions 120 may assign a capability score to a user based on a set of actions associated with a task performed by the user. In some implementations, the task may comprise a complexity score. Such a complexity score may, for example, be based upon a number of steps in an expected set of actions associated with the task and/or an expected time to complete an expected set of actions. Other factors may also be used to establish the complexity score, such as the need for interactions with different services, programs, hardware, and/or other users.

The capability score may be assigned on a user by user basis and may be associated with a profile and/or account for that user. For example, a user may have a corporate account to access a network and associated resources such as software, online tools, printers, copiers, etc. The user's actions associated with completing specific tasks may be recorded and/or measured in order to help determine the capability score. Capability scores are referred to herein as a hierarchy for convenience (e.g., a more experienced user may be described as having a higher capability score). Capability scores may be tracked according to such a hierarchy, via a numeric (e.g., one to five) and/or text-based manner (e.g., “novice”, “intermediate”, “expert”).

In some implementations, assign capability score instructions 120 may receive the set of actions associated with the task from the user and compare the received set of actions to the expected set of actions associated with the task. In some implementations, assign capability score instructions 120 may measure a time for the user to complete each of the set of actions associated with the task. Assign capability score instructions 120 may comprise instructions for receiving the set of actions associated with the task from the user and comparing a time taken by the user to complete the received set of actions to the time to complete the expected set of actions associated with the task.

For example, in a recorded workflow, a user may set up a new printing device by installing software and/or drivers, connecting to the device, configuring various options such as network sharing, and printing a test page. This may be compared to an expected set of steps as recorded by an expert user and/or product developer. This comparison may take into account the time to complete each step, the use of additional steps, such as looking up a help document, resetting configurations and/or going back a step, and/or a complexity associated with the task. Setting up a new printer, for example, may comprise a low complexity task due to a relatively few number of steps and short period of time to complete. A user who took 8 steps to complete such a low complexity task, when an expected set comprises only 5 steps, may for example be assigned a lower capability score than a user who completed the same task in 6 steps. Similarly, a user who took three times as long as the expected set of steps took to complete to complete the steps associated with an action may be assigned a lower capability score than a user who took twice as long as the same expected set of steps. Different mixes of time, number of steps, and complexity factors may be used to establish the capability score for a user depending on the situations and actions being undertaken; the preceding are merely illustrative examples.

Method 200 may then advance to stage 220 where device 110 may receive a support request from the user. For example, receive support request instructions 125 may receive a support request from the user. For example, a user may submit a helpdesk ticket, visit a documentation website, open a help menu, and/or take other actions indicative of seeking assistance in accomplishing a task

Method 200 may then advance to stage 225 where device 110 may direct the user to one of a plurality of support options based on the assigned capability score. The plurality of support options may comprise, for example, connecting the user to a live support agent, displaying an interactive guide, directing the user to an online knowledge base and/or support forum, and directing the user to a support document. In some implementations, a knowledge base may comprise a collection of information documents on a variety of topics. For example, a knowledge base may comprise a collection of service and support documentation for a series of products, such as a printer. Individual knowledge base documents may be associated with different components, tasks, workflows, problems, configuration information, etc.

For example, direct user to support instructions 130 may direct the user to one of a plurality of support options based on the assigned capability score. In some implementations, the plurality of support options may comprise connecting the user to a live support agent, connecting the user to an interactive guide, and directing the user to a support document. The lower the user's capability score, the more assistance may be provided. For example, a beginner may be directed to a live-chat session with support personnel in order to walk the user through each step associated with their support request. An intermediate capability user may be connected with an automated system that provides pre-selected guidance to completing the same steps in the understanding that such a capable user may not need to ask additional questions of a live support agent. Continuing the example, an expert capability user may be provided with support documentation that includes advanced options and additional details for a given action the user may be trying to complete. In some implementations, a user who requires additional support beyond what is provided may have their capability score lowered.

Method 200 may then end at stage 250.

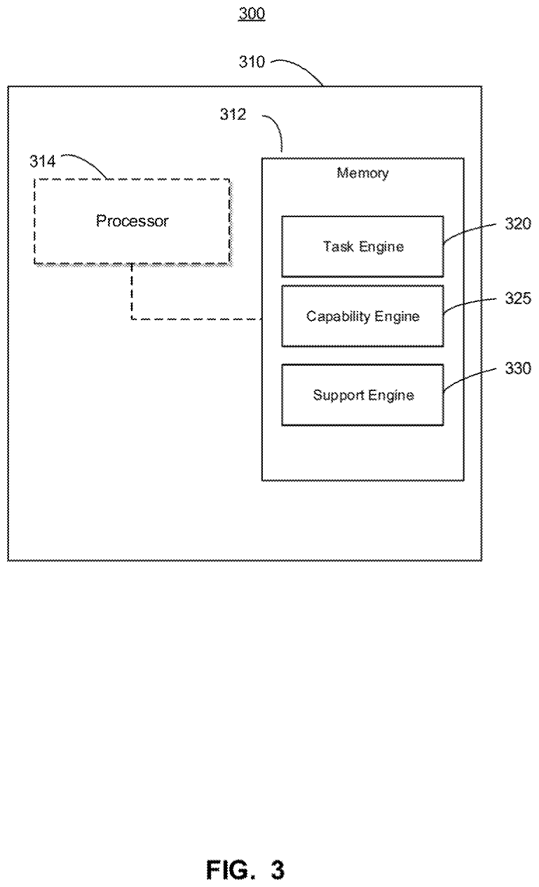

FIG. 3 is a block diagram of an example system 300 for providing a user capability score. System 300 may comprise a computing device 310 comprising a memory 312 and a processor 314. Computing device 310 may comprise, for example, a general and/or special purpose computer, server, mainframe, desktop, laptop, tablet, smart phone, game console, printer and/or any other system capable of providing computing capability consistent with providing the implementations described herein. Computing device 310 may store, in memory 312, a task engine 320, a capability engine 325, and a support engine 330.

Each of engines 320, 325, 330 of system 300 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325, 330. In such examples, apparatus 200 may comprise the machine-readable storage medium storing the instructions and the processing resource to execute the instructions, or the machine-readable storage medium may be separate but accessible to system 300 and the processing resource.

Task engine 320 may identify an expected set of actions associated with a task and assign a complexity score to the task. For example, tasks may be categorized according to a complexity involved to perform the best task footprint. There are different aspects considered to define the task complexity, such as a time to complete the task, a number of steps to complete the task, and how much information is needed on each step of the task. In some implementations, a number of users may be recorded performing the steps to accomplish a particular action (e.g., setting up a network printer). These sets of steps may be referred to as task footprints, and may be analyzed to determine an optimal set of steps and/or time to complete the task. Once the optimal footprint has been identified, which may be verified by a product developer and/or support technician, for example, that footprint may be defined as the expected set of steps for the task.

Capability engine 325 may receive a set of actions associated with the task from a user and assign a capability score to the user by comparing the received set of actions to the expected set of actions associated with the task. For example, assign capability score instructions 120 may assign a capability score to a user based on a set of actions associated with a task performed by the user. In some implementations, the task may comprise a complexity score. Such a complexity score may, for example, be based upon a number of steps in an expected set of actions associated with the task and/or an expected time to complete an expected set of actions. Other factors may also be used to establish the complexity score, such as the need for interactions with different services, programs, hardware, and/or other users.

The capability score may be assigned on a user by user basis and may be associated with a profile and/or account for that user. For example, a user may have a corporate account to access a network and associated resources such as software, online tools, printers, copiers, etc. The user's actions associated with completing specific tasks may be recorded and/or measured in order to help determine the capability score. Capability scores are referred to herein as a hierarchy for convenience (e.g., a more experienced user may be described as having a higher capability score). Capability scores may be tracked according to such a hierarchy, via a numeric (e.g., one to five) and/or text-based manner (e.g., “novice”, “intermediate”, “expert”).

In some implementations, assign capability score instructions 120 may receive the set of actions associated with the task from the user and compare the received set of actions to the expected set of actions associated with the task. In some implementations, assign capability score instructions 120 may measure a time for the user to complete each of the set of actions associated with the task. Assign capability score instructions 120 may comprise instructions for receiving the set of actions associated with the task from the user and comparing a time taken by the user to complete the received set of actions to the time to complete the expected set of actions associated with the task.

For example, in a recorded workflow, a user may set up a new printing device by installing software and/or drivers, connecting to the device, configuring various options such as network sharing, and printing a test page. This may be compared to an expected set of steps as recorded by an expert user and/or product developer. This comparison may take into account the time to complete each step, the use of additional steps, such as looking up a help document, resetting configurations and/or going back a step, and/or a complexity associated with the task. Setting up a new printer, for example, may comprise a low complexity task due to a relatively few number of steps and short period of time to complete. A user who took 8 steps to complete such a low complexity task, when an expected set comprises only 5 steps, may for example be assigned a lower capability score than a user who completed the same task in 6 steps. Similarly, a user who took three times as long as the expected set of steps took to complete to complete the steps associated with an action may be assigned a lower capability score than a user who took twice as long as the same expected set of steps. Different mixes of time, number of steps, and complexity factors may be used to establish the capability score for a user depending on the situations and actions being undertaken; the preceding are merely illustrative examples.

Assign capability score instructions 120 may comprise instructions to assign a second capability score to a second user based on a second set of actions associated with the task performed by the user. That is, different users may be assigned different capability scores based on the steps used, time taken, or other factors associated with completing the same task. In some implementations, users' capability scores may be periodically re-evaluated and raised or lowered.

Support engine 330 may receive a support request from the user and direct the user to one of a plurality of support options based on the assigned capability score. For example, receive support request instructions 125 may receive a support request from the user. In some implementations, a user may submit a helpdesk ticket, visit a documentation website, open a help menu, and/or take other actions indicative of seeking assistance in accomplishing a task. For example, direct user to support instructions 130 may direct the user to one of a plurality of support options based on the assigned capability score. In some implementations, the plurality of support options may comprise connecting the user to a live support agent, connecting the user to an interactive guide, and directing the user to a support document. The lower the user's capability score, the more assistance may be provided. For example, a beginner may be directed to a live-chat session with support personnel in order to walk the user through each step associated with their support request. An intermediate capability user may be connected with an automated system that provides pre-selected guidance to completing the same steps in the understanding that such a capable user may not need to ask additional questions of a live support agent. Continuing the example, an expert capability user may be provided with support documentation that includes advanced options and additional details for a given action the user may be trying to complete. In some implementations, a user who requires additional support beyond what is provided may have their capability score lowered.

Although one computing device 310 is depicted in FIG. 3, certain implementations of system 300 may comprise more than one computing device 310. At least one of the computing devices may be employed and arranged, for example, in at least one server bank, computer bank, data center, and/or other arrangements. For example, the computing devices together may include a cloud computing resource, a grid computing resource, and/or any other distributed computing arrangement. Such computing devices may be located in a single installation and/or may be distributed among many different geographical locations.

The disclosed examples may include systems, devices, computer-readable storage media, and methods for document element re-positioning. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

What is claimed is:

1. A non-transitory machine readable medium storing instructions executable by a processor to:
assigning a capability score to a user based on a set of actions associated with a task performed by the user;
receiving a support request from the user; and
directing the user to one of a plurality of support options based on the assigned capability score.

2. The non-transitory machine readable medium of claim 1, wherein the task comprises a complexity score.

3. The non-transitory machine readable medium of claim 2, wherein the complexity score is based at least in part on a number of steps in an expected set of actions associated with the task.

4. The non-transitory machine readable medium of claim 3, wherein assigning a capability score to the user comprises:
receiving the set of actions associated with the task from the user; and
comparing the received set of actions to the expected set of actions associated with the task.

5. The non-transitory machine readable medium of claim 2, wherein the complexity score is based at least in part on an expected time to complete an expected set of actions.

6. The non-transitory machine readable medium of claim 5, wherein assigning the capability score to the user comprises measuring a time to complete each of the set of actions associated with the task.

7. The non-transitory machine readable medium of claim 3, wherein assigning a capability score to the user comprises:
receiving the set of actions associated with the task from the user; and
comparing a time taken by the user to complete the received set of actions to the time to complete the expected set of actions associated with the task.

8. The non-transitory machine readable medium of claim 1, wherein the instructions to assign the capability score to the user further comprise instructions to assign a second capability score to a second user based on a second set of actions associated with the task performed by the user.

9. The non-transitory machine readable medium of claim 1, wherein the plurality of support options comprise at least one of the following: connecting the user to a live support agent, connecting the user to an interactive guide, and directing the user to a support document.

10. A method comprising:
receiving a set of actions associated with a task from a user;
assigning a capability score to the user by comparing the received set of actions to an expected set of actions associated with the task;
receiving a support request from the user; and
directing the user to one of a plurality of support options based on the assigned capability score.

11. The method of claim 10, wherein the plurality of support options comprise at least one of the following: connecting the user to a live support agent, connecting the user to an interactive guide, directing the user to a knowledge base, and directing the user to a support document.

12. The method of claim 10, wherein assigning the capability score to the user by comparing the received set of actions to the expected set of actions associated with the task comprises identifying deviations between the received set of actions and the expected set of actions.

13. The method of claim 10, wherein assigning the capability score to the user by comparing the received set of actions to the expected set of actions associated with the task comprises identifying a complexity score associated with the task.

14. The method of claim 13, wherein the complexity score associated with the task is based on at least one of the following: a number of steps in the expected set of actions and a time to complete the expected set of actions.

15. A system, comprising:
a task engine to:
identify an expected set of actions associated with a task, and
assign a complexity score to the task;
a capability engine to:
receive a set of actions associated with the task from a user, and
assign a capability score to the user by comparing the received set of actions to the expected set of actions associated with the task; and
a support engine to:
receive a support request from the user, and
direct the user to one of a plurality of support options based on the assigned capability score.
